(19) United States
(12) Patent Application Publication
(10) Pub. No.: US 2016/0361848 A1
(43) Pub. Date: Dec. 15, 2016

(54) MOLDED FOAM SUBSTRATE BACKING, TOOL, AND PROCESS

(71) Applicant: FRIMO Inc., Wixom, MI (US)

(72) Inventors: Derek L. Roberts, Clarkston, MI (US); Kevin A. Hindersman, Commerce Township, MI (US)

(21) Appl. No.: 15/174,151

(22) Filed: Jun. 6, 2016

Related U.S. Application Data
(60) Provisional application No. 62/173,110, filed on Jun. 9, 2015.

(51) Int. Cl. B29C 44/58; B29C 33/00; B29C 44/60; B29C 33/18; B29C 44/12; B29C 33/10; B29C 33/42

(52) U.S. Cl. CPC B29C 44/588; B29C 33/10; B29C 33/0044; B29C 33/42; B29C 33/18; B29C 44/1219; B29C 44/60; B29K 2075/00

(57) ABSTRACT

An article including a substrate having a first surface, an opposing second surface and a peripheral edge defined between the first surface and the second surface. A shaped foam body made of a polymeric material is attached to the substrate. In the space between the peripheral edge of the substrate and a peripheral edge of the shaped foam body, there is a margin that is substantially free of any polymeric material of the shaped foam body, and a border area that includes an exposed extension of the polymeric material of the shaped foam body having a substantially predetermined shape and size. A tool and process for making the above is described as well.

### CLAIM OF PRIORITY

The present application claims the benefit of the filing date of U.S. Patent Application No. 62/173,110, filed on Jun. 9, 2015 which is hereby incorporated by reference in its entirety.

### FIELD

In general, the present teachings relate to an improved molded foam and substrate layered article, tool, and process therefor. More particularly, though having aspects making it particularly adaptable to mold a foam backing layer onto a carpet substrate, the present teachings are directed mainly at deriving a substrate having a molded foam layer having an exposed outer surface,

### BACKGROUND

Foam backed structures are used in many automotive and other applications, particularly when desirable to impart a cushiony feel to a surface to which a user comes into contact. One approach has been to mold a polymeric foam onto or between a substrate.

The ability to produce relatively large parts (e.g., parts that are sized to a substantial portion of an automotive vehicle cabin) is often difficult. Large part size may contribute to the potential for non-homogeneous densities. The parts tends to have relatively thin sections. As a result, since the foams tend to cure-in-place, and liberate heat and/or gas, there also may be a need to invoke special measures to vent a mold and/or regulate temperature. In addition, in many instances, it is necessary to use excess reactant starting materials to produce a high quality foam material.

Consequently, notwithstanding many existing efforts, there remains a need for improved articles having a foam layer, such as carpets having a foam backing layer (e.g., for use in an automotive vehicle interior).

The following patent documents may be related to the present invention: United States U.S. Pat. No. 6,361,054 (denier et al.), U.S. Pat. No. 6,315,295 (Sym), U.S. Pat. No. 5,334,338 (Kittel et al.), U.S. Pat. No. 3,046,177 (Hankins), U.S. Pat. No. 2,950,221 (Bauer et al.), U.S. Pat. No. 2,841,205 (Bird); Published U.S. Patent Application No, US20130341817A1 (Heffelbower); and European (EP) Patent Application Nos. EP1640646A1 (Kunzmann), EP1683993A1 (Pitz et al.); and Canadian Patent Application No. CA2646523A1, all of which are incorporated by reference herein for all purposes. Instrument panels have been produced using a system having features within the description of U.S. Pat. No. 6,361,054 (Denker et al.) and EP1640646A1 (Kunzmann), pursuant to which a foam material layer having a thickness typically below 10 mm is cured in place between opposing non-porous layers as a sandwich structure. The edges of the resulting product typically conceal and do not expose the foam.

### SUMMARY

The present teachings make use of a simple, yet elegant, approach by which relatively few components can be employed for achieving a high quality article having a substrate and a polymeric foam body attached thereto, an example of which includes a foam backed carpet, such as one in which the foam is cured in place to attach to the carpet.

In general, the teachings relate to an article including a substrate having a first surface, an opposing second surface and a peripheral edge defined between the first surface and the second surface. A shaped foam body made of a polymeric material may be attached to the substrate. The shaped foam body may have a first surface in contact (direct or indirect) with the second surface of the substrate over at least a portion (e.g., over a major portion) thereof, an opposing second surface, and a peripheral edge defined between the first surface and the second surface. In the space between the peripheral edge of the substrate and a peripheral edge of the shaped foam body, there may be a margin that is substantially free of any polymeric material of the shaped foam body, and a border area that includes an exposed extension of the polymeric material of the shaped foam body having a generally predetermined shape and size.

The article may have any of the following features, alone or in combination. The substrate may be a carpet. The polymeric material of the shaped foam body may be a polyurethane. The polymeric material may be a cure-in-place polyurethane. The shaped foam body may be attached by an adhesive bond to the substrate. The margin may extend around substantially the entirety of the peripheral edge of the shaped foam body. The margin may be spaced apart from the peripheral edge of the shaped foam body by the border area (e.g., only by the border area). The margin may consist of the substrate. The border area may extend around substantially the entirety of the peripheral edge of the shaped foam body. The second surface of the shaped foam body may be free of any layer that covers the peripheral edge of the shaped foam body. The second surface of the shaped foam body may be free of any layer.

A tool and process for making the above is described as well. The tool and process employ at least one seal device, such as an inflatable seal assembly or other device that can be controlled to change a cross-sectional dimension, which can be operated to selectively open and close a gap between opposing portions of a mold. The mold will have a cavity structure adapted to receive the substrate and a reactant mixture for forming the polymeric foam to have a shape defined at least in part by the cavity structure. When the gap is closed, the at least one seal device bears against the substrate (which desirably may be a single substrate located on only one surface of the foam body, such as an elastically compressible substrate, e.g., a carpet). Thus, it can be seen that the resulting foam body, in its expanded state may directly contact a wall defining a mold cavity during manufacture. The present teachings contemplate a method of making an article as described herein. The method may comprise a step of foam molding the shaped foam body in at least one cavity of a tool that also carries the substrate. The method may include intermittently venting the tool with an assembly that controllably opens and closes a gap between opposing mold portions of the tool.

The method may include any of the following steps or features, alone or in combination. The method may include elastically compressing the substrate without plastically deforming it while closing the gap between opposing mold portions of the toot The method may include a step of positioning the substrate in the gap between a first mold portion and a second mold portion opposite the first mold portion of a mold so that the margin of the substrate may be positioned in alignment with at least one inflatable seal assembly carried on at least the first mold portion. The method may include introducing a fluid reactant mixture into a mold cavity of the second mold portion so that it may fill and/or at least partially contact the mold cavity and may at least partially contact the substrate. The method may include curing the reactant mixture while it remains in the mold cavity. The method may include intermittently deflating the at least one inflatable seal assembly from an inflated state to a deflated state to vent gases that may build up within the mold. The method may include intermittently inflating the at least one inflatable seal assembly from a deflated state to an inflated state so that both first and second mold portions may contact the substrate. The method may include a step of drawing at least a partial vacuum (e.g., to help secure the substrate in place). The steps of the method may be performed to include intermittently inflating and deflating one or more tubes of an inflatable seal assembly to vent gases that build up within the mold. The steps of the method may be performed to cause one or more tubes to directly contact and elastically compress the substrate without plastically deforming the substrate.

The tool may comprise any of the following features, alone or in combination. The tool may be used for making the article as described herein. The tool may be for use in the methods described herein. The tool may include a first mold portion. The tool may include a second mold portion adapted to be brought into opposing relation with the first mold portion. The first and/or second mold portions may be adapted to receive a substrate in a space between the first mold portion and the second mold portion. At least the second mold portion may have a cavity defined therein. At least the second mold portion may have at least one inlet through which a fluid reactant mixture can be introduced into the cavity for filling the cavity. The tool may include at least one gap-defining assembly that may extend around at least a portion of a periphery of the cavity. The gap-defining assembly may be carried on the first mold portion. The at least one gap-defining assembly may be adapted for engaging the substrate during a molding operation, when in a first state. The at least one gap-defining assembly may be for causing a venting gap to arise between at least a portion of the first and second mold portions when in a second state. The cavity may be configured so that the molded article has a shape of a floor covering for a vehicle; the second mold portion may include a plurality of openings through which a vacuum can be drawn; or both. The at least one gap-defining assembly may include at least one inflatable seal assembly. A first inflation state may arise upon the presence of a first volume of gas in the at least one inflatable seal assembly. A second inflation state may arise upon the presence of a second volume of gas in the at least one inflatable seal assembly, which may be higher than the first volume of gas. The at least one inflatable seal assembly may be located within a groove in the first mold portion. Upon inflation, at least a portion of the inflatable seal assembly may extend outside of the groove for directly or indirectly engaging an upper surface of the substrate. It is contemplated that only one of the mold portions, and not an opposing mold portion, may include at least one gap-defining assembly or an inflatable seal assembly. Either or both of the first mold portion and the second mold portion may include ports for fluid communication with a device for drawing a vacuum for helping to secure the substrate in position.

The present teachings also contemplate a system containing the tool as described herein. The system may include a source of fluid (e.g., gas) in fluid communication with the at least one inflatable seal assembly, a regulator for controllably introducing fluid from the source of fluid to the at least one inflatable seal, a press (optionally carrying one or more platens for supporting one or more mold portions), a controller that controls the frequency, duration and/or amount of fluid to the at least one inflatable seal assembly, or a combination thereof.

### BRIEF DESCRIPTION OF THE DRAWINGS

FIG. 1 is an enlarged sectional view of a portion an illustrative article of the teachings.

FIG. 2 is a perspective view of an illustrative article in accordance with the present teachings viewed from the bottom.

FIG. 3 is a side sectional view of a tool for making an article according to the present teachings.

FIG. 4 is a perspective view of a mold portion carrying components of a sealing assembly.

FIG. 5A is a side sectional view of an illustrative tool according to the present teachings.

FIG. 5B is an enlarged sectional view of a portion of the tool of FIG. 5A without an inflatable tube shown.

### DETAILED DESCRIPTION

As required, detailed embodiments of the present teachings are disclosed herein; however, it is to be understood that the disclosed embodiments are merely exemplary of the teachings that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present teachings.

In general, and as will be appreciated from the description that follows, the present teachings relate generally to an article that includes, consists essentially of, or consists of a substrate (e.g., a fibrous substrate, such as a carpet, which may or may not have been previously shaped such as by thermoforming or some other deformation processing), and a shaped foam body attached directly or indirectly (e.g., by an intermediate film layer, by, some other coating or layer, or otherwise) to the substrate.

The article may be a foam backed carpet. The article may be a foam backed interior trim surface for a vehicle, such as an automotive vehicle. The article may be a foam backed carpet for an interior of an automotive vehicle. The article may have a contoured three dimensional configuration. For example, the article may have a three dimensional contoured structure by which the article is able to be positioned in place on top of sheet metal or other structure defining a contoured floor of an automotive vehicle. Various respective contours of the article may be such as to correspond generally with and follow along substantially in contact with the topography or an interior structure of an automotive vehicle interior sheet metal of a vehicle body-in-white. Thus, the article may be contoured to include features adapted to cover a tunnel (e.g., a transmission tunnel), console, a seat mount, a bracket, an anchor, a floor pan, or some other underbody assemblies. Of course, the teachings herein are not limited to the above articles, and may have, other applications as well.

The substrates herein may have a first surface (e.g., an upper surface that may be exposed to view in service). It may have an opposing second surface (e.g., an upper surface that may be exposed to view in service). The first surface and the second surface may be generally parallel. The first surface, the second surface or both, may be synthetic or polymeric. The first surface, the second surface or both, may be fibrous. The first surface, the second surface or both, may be porous.

The substrates may have a peripheral edge defined between the first surface and the second surface. The substrate may have an average thickness (Tₛ). The peripheral edge may have a thickness as well (e.g., it may be generally the thickness of the substrate). The thickness of the substrate may be generally constant (e.g., with variation of less than about +/−20% or 10% of the average thickness) over substantially the entirety (e.g., over at least about 95%) of the total substrate volume. The thickness may vary across the substrate according to a generally predetermined design (e.g., in a repetitious pattern). The second surface may have a coating and/or other layer thereon, over selected portions of or substantially all (e.g., over at least about 90% of the area of the surface) of its surface.

When the substrate is a carpet, it may include an upper layer of fibers or pile. The distal ends of the fibers or pile may define the first surface. The pile may include natural and/or polymeric fibers (e.g., a thermoplastic, such as a polyolefin, a polyester (e.g., polyethylene terephthalate), a polyamide, poly-(meth)acrylic, or otherwise). The fibers may be present in tufts. The fibers may be present in a woven form.

The substrate may be provided in a generally flat or unformed state. The substrate may be provided in a three-dimensional form. For example, the substrate may be thermoformed or otherwise subjected to an application of heat and/or pressure to transform an unshaped form into a three dimensional configuration (e.g., into a configuration that is adapted to be located over a vehicle component, such as a floor).

Turning now to the shaped foam body, it will be made of a polymeric material. The polymeric material may be a material that is curable generally at or within about 50°, 40°, 30°, 20°, or 10° C. of room temperature. The polymeric material may be curable at a temperature below (e.g., at least about 10°, 20°, 30°, 40°, 50° C. or more below the lowest peak melting temperature or lowest glass transition temperature of the substrate, or at least of the fibrous material of the substrate when it is a carpet). One illustrative material for the polymeric material is a polyurethane (e.g., a reaction product of at least one polyol and one isocyanate, whether or not in the presence of any catalyst). The foam body may be an open cell foam, a closed cell foam or a combination thereof. The foam body may have a skin that forms on its outer surface. The skin may be a region at which the density of the foam body is within at least about 50%, 60%, 70%, 80%, 90% or higher of the theoretical density for the material of the foam in an unfoamed state.

The shaped foam body is attached directly or indirectly, to the substrate. The shaped foam body has a first surface (e.g., an upper surface for being attached to a carpet backing), in contact (direct or indirect) with the second surface of the substrate over a major portion of the foam body first surface (e.g., at least about 50%, 60%, 70%, 80%, 90% or more of the area of the first surface of the foam body is attached in contact with the substrate (e.g., via the second surface of the substrate)). The shaped foam body has an opposing second surface. A peripheral edge is defined between the first surface and the second surface. The shaped foam body may have one or more thicknesses, and may have an average thickness (T_{F}), defined by the distance between the first and second surfaces of the body. The average thickness of the shaped foam body may be at least about 3 mm, 5 mm, 10 mm, 20 mm or thicker. The average thickness of the shaped foam body may be below about 50 mm, 35 mm, or 25 mm or thinner.

Typically the foam body will not span entirely coextensively with the entirety of the substrate. Thus, it is expected that there may be a space between the peripheral edge of the substrate on the second surface of the substrate and the peripheral edge of the shaped foam body. That space, is regarded herein as a margin of the substrate. For articles herein, the margin of the substrate may be substantially free (i.e., contains no greater than 10% 5%, 3% or 1% of the total weight of the total weight of the polymeric material of the shaped foam body) of any waste polymeric material of the shaped foam body, except as may have been predetermined. The articles may also include a border area. The border area may adjoin the shaped foam body and be at least partially continuous with it. The border area may thus include an exposed extension of the polymeric material of the shaped foam body having a predetermined shape and size. For example, the border area may have a predetermined shape and size that may be any combination of one or more generally constant width(s), generally constant length(s), generally constant thickness(es), peripheral edge slope(s), peripheral edge curvatures, predetermined pattern(s), generally constant density(ies). The predetermined shape and size may span over at least 20%, 40%, 60%, 80%, 90% or 95% of the total border area. As with the margin of the substrate, the border may be substantially free (i.e., contains no greater than 10%, 5%, 3%, or 1% of the total weight of the total weight of the polymeric material of the shaped foam body) of any waste polymeric material of the shaped foam body, except as may have been predetermined. Thus, it can be seen that the resulting shaped foam body is that of its generally predetermined shape and size.

As can be appreciated from the above, the polymeric material for the foam body may be a cure-in-place polymer, such as a polyurethane. The shaped foam body may be attached by an adhesive bond to the substrate.

The margin may extend partially around (e.g., less than about 80%, 70%, 60%, 50%, 40%, 30% or lower) the entirety of the peripheral edge of the shaped foam body, as measured by comparing the total lengths of the peripheral edge and the margin. The margin may extend substantially entirely around (e.g., more than about 85%, 90%, or 95%) the entirety of the peripheral edge of the shaped foam body, as measured by comparing the total lengths of the peripheral edge and the margin. The margin may have one or more widths (W_{M}) ranging from about 0 to about 200 mm, about 5 to about 100 mm, or about 10 to about 75 mm. The margin may be spaced apart from the peripheral edge of the shaped foam body only by the border area.

The articles herein may have a margin that consists of the substrate. The articles may be free of any layer that would encapsulate or sandwich the foam body. The articles herein may be such that the second surface of the shaped foam body is free of any layer that covers the peripheral edge of the shaped foam body. The second surface of the shaped foam body may be free of any layer.

The border may extend partially around (e.g., less than about 80%, 70%, 60%, 50%, 40%, 30% or lower) the entirety of the peripheral edge of the shaped foam body, as measured by comparing the total lengths of the peripheral edge and the border. The border may extend substantially entirely around (e.g., more than about 85%, 90%, or 95%) the entirety of the peripheral edge of the shaped foam body, as measured by comparing the total lengths of the peripheral edge and the border. The border may have one or more average widths (W_{B}) ranging from about 0 to about 200 mm, about 5 to about 100 mm, or about 10 to about 75 mm.

The margin, the foam body, and the border portion may each be exposed to view in an article as manufactured. The border portion may be characterized as having one or more average width(s) less than about 25 mm, 20 mm, 15 mm or 10 mm. The border portion may have one or more maximum width(s) (W8) less than about 150 mm, 100 mm, or 50 mm. The border portion may have one or more average thickness(es) (T_{B}) less than about 5 mm, 3 mm, 2 mm or 1 mm. The border portion may have a maximum thickness of less than about 50 mm, 35 mm, 25 mm, 10 mm, or 5 mm. The width of the border portion may be generally uniform about the peripheral edge of the foam body. Far example, deviations from the average width may be less than about +/−30%, 20% or 18% of the average width.

The maximum overall thickness (T_{MAX}) of articles (i.e., the cross sectional thickness taken through the article from the outermost surfaces of the, article) of the present teachings may be below about 100 mm, 80 mm, 60 mm, 50 mm, 40 mm, or 30 mm.

Turning now to a tool useful for the present teachings, it is possible that the tool will include at least two opposing mold portions. The mold portions may each have an opposing face that opposes another opposing face of the other mold portion. A first mold portion (e.g., an upper mold portion) may be adapted to receive the substrate (e.g., carpet) of the teachings. For example, the first mold portion may be adapted to receive the substrate (e.g., carpet) after the substrate has been shaped into a three dimensional configuration; e.g., after a thermoforming operation performed upon the substrate (e.g., carpet). At least one of the mold portions, e.g., a second mold portion (e.g., a lower mold portion) may have a cavity for defining the desired shape for the foam body. The cavity may be defined inwardly relative the opposing face of the mold portion. The first portion, the second portion, or both, may also include at least one inlet through which a fluid reactant mixture can be introduced to fill the cavity. The mold portions may each have one or more channels defined therein through which a fluid or other heat transfer medium is located or passed, in order to help regulate mold temperature. Associated hardware may also accompany, e.g., a pump, a heater, an electrical supply, a suitable controller that controls the frequency, duration and/or amount of fluid to the at least one inflatable seal assembly, etc.

An inflatable seal assembly may be positioned between the mold portions. An example of an inflatable seal assembly is one that includes one or more tubes that can be selectively inflated or deflated, such as by a pressurized fluid (e.g., a gas, such as air). The tubes may be located between mold portions. For example, tubes may reside within one or more grooves at least partially surrounding the cavity. More particularly, tubes of the at least one inflatable seal assembly may extend around at least a portion of the periphery of the cavity of the first mold portion (e.g., upper mold portion) and/or second mold portion (e.g., lower mold portion), the at least one inflatable seal assembly being adapted for engaging the substrate during a molding operation, when in a first inflation state, and for permitting a venting gap to exist between at least a portion of the first and second mold portions when in a second inflation state.

Either or both of the mold portions may be such that they are adapted to receive an elastically compressible substrate (e.g., a fibrous substrate such as a carpet) in a space between the first mold portion and the second mold portion. The at least one inflatable seal assembly by itself or in combination with the first or second mold portions, is adapted for elastically compressing the substrate during a molding operation, without plastically deforming the substrate, while also preventing any appreciable amounts of the reactant mixture (e.g., amount for forming a foam in an amount of below about 10%, 5%, 3% or 1% of the total foam weight) from escaping to beyond a predetermined border of the foam body.

One or both of the mold portions may include a plurality of ports through which a vacuum can be drawn; thus, either or both of the first mold portion or the second mold portion may include ports for fluid communication with a device for drawing a vacuum for helping to secure the substrate in position. One or both of the mold portions may include a cavity for defining a predetermined shape. One or both of the mold portions may include an outwardly projecting surface portion adapted to be generally matingly received within a cavity of an opposing mold portion. One or both of the mold portions may have a base (e.g., a plate). Either or both of the mold portions may be adapted to mount to a press, e.g., by way of a press platen. Either or both of the mold portions may be adapted to receive and/or may include one or any combination of at least one electrical connector, at least one pressure regulator, at least one valve manifold, at least one flange for connecting with a fluid source, at least one sensor (e.g., an optical sensor, a fiber optic sensor or otherwise, fear sensing the relationship as between mold portions), at least one valve box (e.g., with a lid).

Any cavity defined in either of the mold portions may be configured so that the molded article has a shape of a floor covering for a vehicle (e.g., it has a shape for defining a desired foam body that will cover a floor of the vehicle). The mold portion opposite the cavity may have a topography adapted to complement the structure of a shaped substrate (e.g., a thermoformed substrate). For example, it is possible that the mold portion opposite the cavity has a topography adapted to generally complement the structure of the shaped substrate. Thus, it is possible that the mold portion opposite the cavity may have a structure that preserves substantially in tact the shape of the shaped substrate both prior to and following the formation of the attached foam body.

Other aspects of the tool may include that the either or both of the first or second mold portions may include a cavity having a predetermined shape. Either or both of the first or second mold portions may include one or more outward projections (e.g., projecting outward relative to a surface that has a predetermined shape). For example, either or both of the first or second mold portions may include a base plate and may include one or more projections directed away from the base plate and toward an opposing mold portion.

The tubes may remain elastic, without yielding or deforming plastically, throughout the manufacturing operation. The tubes may be inflatable. The, tubes may be in controlled fluid communication with a fluid source, so that fluid may be introduced into the tube to increase pressure within the tube for inflating the tube. The tubes may also be deflatable in a controlled manner. For example, a fluid contained in a tube may be vented to atmosphere to cause deflation. The one or more tubes may be located at least partially within one or more grooves of one or more of the mold portions. One or more tubes of at least one inflatable seal assembly may be located within a groove in either or both of the first mold portion or the second mold portion, and at least upon inflation at least a portion of one or more of the tubes of the inflatable seal assembly may thus extend outside of the groove for directly or indirectly engaging the substrate. By way of example, one or more tubes of at least one inflatable seal assembly may be located within a groove in the first mold portion (e.g., in an upper mold portion).

By way of illustrations applicable in general to the teachings herein, one or more tubes of the at least one inflatable seal assembly may be located within a groove in one of the mold portions (e.g., in an upper mold portion, in the mold portion opposite the mold portion through which any reactant mixture is introduced, or both). One or more tubes of the at least one inflatable seal assembly may be located so during the formation of the foam body, the one or more tubes contact an outer surface of the substrate (e.g., an upper surface of a carpet) that is positioned between the mold portions.

The tool may be employed or provided as a kit in combination with other components (e.g., as part of an apparatus) that may include one or more of a source of fluid (e.g., gas) in fluid communication with the at least one inflatable seal assembly; a regulator for controllably introducing fluid from the source of fluid to the at least one inflatable seal: a device (e.g., a pump) for drawing a vacuum; and/or at least one controller that controls the frequency, duration and/or amount of fluid to the at least one inflatable seal assembly.

A protective film or other covering (e.g., a temporary covering) may be employed to isolate the tube surface from any reactant mixture introduced into the mold cavity. An example of an arrangement that may be adapted for the present purpose is found in U.S. Pat. No. 6,361,054 (Denker et al.), incorporated by reference. One possible benefit of the present teachings is that the articles herein may be formed, and the method performed, in the absence of any protective film or other covering (e.g., a temporary covering). Thus, there may be no protective film or other covering (e.g., temporary covering) between a wall of a mold, any tube or seal, or each, and the reactant mixture. For instance, it is envisioned that one or more tubes of at least one inflatable seal assembly may be positioned in either or both of the first mold portion or the second mold portion, and at least upon inflation at least a portion of one or more of the tubes of the inflatable seal assembly may thus isolate the one or more tubes from direct exposure to any reactant mixture introduced into the mold cavity.

Also within the teachings is a method for making the articles herein. The method generally contemplates inserting a substrate (e.g., a single substrate) into a mold (e.g., a mold as described herein, such as one that is adapted for making an article as described herein), introducing a reactant mixture into a cavity of the mold, curing in place the reactant mixture to define a foam body that is in contact with the substrate, and further results in a border of the material of the foam body at least partially around the foam body, and may also include a margin of the substrate at least partially around the border.

In more particularity, such a method may include steps of positioning the substrate between a cavity of opposing mold portions (such as between the first mold portion (e.g., an upper mold portion) and the second mold portion (e.g., the lower mold portion) opposite the first mold portion. The substrate may be positioned so that the margin of the substrate is positioned in alignment with at least one inflatable seal assembly carried, on a mold portion (e.g., on at least, or on only, the first mold portion). A fluid reactant mixture may be introduced into the cavity of the second mold portion so that it fills the mold cavity and it contacts the substrate. A step of curing the reactant mixture while it remains in the mold cavity may be performed. Also, there may be one or more steps of intermittently inflating the inflatable seal from an inflated state to a deflated state to vent gasses that build up within the mold; and/or intermittently deflating the inflatable seal from an inflated state to a deflated state so that both first and second portions of the mold contact the substrate. The method may also include a step of drawing at least a partial vacuum (e.g., through the first or upper mold portion) to help secure the substrate in place.

By way of illustration, the substrate (e.g., carpet) may be placed between opposing mold portions. The substrate may be positioned so that it may be held in place, such as by being drawn toward and/or against a first surface of the one of the mold portions (e.g., by a vacuum). The substrate may be positioned so that it may be held in place, such as by being drawn toward and/or against one or more tubes of the inflatable seal assembly. A reactants mixture may be introduced into the second mold portion. One or both of the first or second mold portions are moved relative to each other until there is only a small gap between directly opposing surfaces of the mold portions. As it starts to cure and foam, the reactants mixture located in the mold cavity expands, causing the mold cavity to become filled with polymeric foam, and causing the expanding polymeric foam to expand and bond with the substrate. During this filling process, at least a portion of any gas located in the mold cavity can be forced out of the mold cavity through a slight gap between opposing mold surfaces. When the foam mixture penetrates into a gap area, pressure can be applied to the sealing tube for inflating it for one or more periods of time. In this manner the gap is gradually closed by inflating the tube. The teachings herein may be free of any step of employing a protective film such as that employed in U.S. Pat. No. 6,361,054. As seen, the teachings herein generally relate to a non-continuous or batch type manufacturing technique.

It bears noting that one of the surprising features of the present teachings is the ability to employ the sealing described herein, and achieve a high integrity product with relatively small amounts of waste foam reactant materials, particularly when only a single substrate is employed, when the substrate employed is a generally porous substrate (e.g., a carpet or other textile, or both) and/or compressibly elastic without plastic deformation. Surprisingly, the elimination of a second substrate that works with a first substrate to sandwich a foam within the margins of those substrates does not result in any significant amounts of waste. Moreover, the fact that the substrate may be porous and/or compressibly elastic without plastic deformation does not prohibit the ability to achieve the resulting controlled border structure, and/or control over substrate margins.

As can be seen from the above, the tool and method herein may employ at least one seal device, such as an inflatable seal assembly or other device that can be controlled to change a cross-sectional dimension, which can be operated to selectively open and close a gap between opposing portions of a mold. When the gap is closed, the at least one seal device bears against the substrate (which desirably may be a single substrate located on only one surface of the foam body). Thus, the foam body, in its expanded state will directly contact a wall defining a mold cavity during manufacture.

The teachings herein also contemplate a system that includes the tool of the present teachings. The system may include a source of fluid (e.g., gas) in fluid communication with the at least one inflatable seal assembly. The system may include a regulator for controllably introducing fluid from the source of fluid to the at least one inflatable seal. The system may include a press, which may include one or more platens, for supporting (and/or translating one or more mold portions relative to each other, such as raising and lowering of at least one mold portion). The system may include a controller that controls the frequency, duration and/or amount of fluid to the at least one inflatable seal assembly.

The tool of the present teachings may include one or more heat transfer components. For example, a mold portion may include one or more lines through which a heat exchange fluid is circulated.

It should also be appreciated that when the assembly is in a vented condition one or more of the mold portions (e.g., each of two opposing mold portions) may be held in a fixed position relative to each other. A gap may be defined therebetween. The average gap between opposing mold surfaces (e.g., at a location laterally within about 25 mm of a longitudinal axis of a tube) may be about 1 to about 10 mm, or about 2 to about 5 mm (e.g., about 3.5 mm). When the assembly is in a vented condition, one or more of the mold portions may be moved apart from each other to define a larger gap between them. For example, one or more platens carrying the mold portions may be controlled to raise or lower relative to the respective other mold portion for altering the gap.

One or more of the tubes may be made of a polymeric material, e.g., a polymeric material that has a sufficient balance of elasticity and rigidity to help secure the substrate against a mold portion during foaming of the reactant mixture. Tubes for an inflatable seal assembly may reside in a groove that is defined within at least the first mold portion. The groove may have a cross-sectional profile that includes an undercut and/or includes no undercut. Thus a transverse opening at the surface of the groove may have a lateral dimension that is smaller than and/or equal to the maximum transverse width of the groove.

The tubes are adapted so that the tool can be operated for intermittently deflating the inflatable seal from an inflated state to a deflated state to vent gasses that build up within the mold. During this deflating operation, one or more (e.g., both of two opposing mold portions) mold portions can either be in a in a fixed position or moved relative to each other to create bigger gap between opposing mold portions. The tubes are adapted so that the tool can be operated for intermittently inflating the inflatable seal from a deflated state to an inflated state so that both first and second portions of the mold contact the substrate that is located between them (e.g., at least a portion of the margin of a substrate may be aligned in direct opposing relation with one or more tubes).

With further reference to the tubes, as generally applicable herein, a transverse surface may have an average width at the exposed surface (W_{ES}) of about 0.5 to about 25 (about 2 to about 18 mm, about 5 to about 15, or about 10 mm). The outside diameter of a tube (when not inflated) that will reside in the groove may be larger (e.g., by at least about 0.5 mm, 1 mm, 2 mm or more) than or about the same as the average width at the exposed surface (W_{ES}). For example, for a groove having an undercut, the outside diameter of, the tube may be about 10 mm, the average width at the exposed surface may be about 9 mm, and the maximum width of the groove (W_{MAX}) may be about 11 mm. A maximum depth of the groove (D_{MAX})may be generally within about 1 mm, 2 mm, 3 mm, 5 mm or more of the outside diameter of the tube when inserted therein. It is also possible that the groove may have one or more portions that have no undercut. Thus the W_{ES} will approximate the W_{MAX}.

Any such tubing for the inflatable seal assembly may have a wall thickness of about 0.5 to about 2.5 mm (e.g., about 1.5 mm). It may be a silicone material. It may be a polymeric material having a Shore A durometer hardness of about 30 to about 70, about 40 to about 60, or about 50, per ASTM D2240-05(2010). One or more elbow t-joints or t-joints, or other joints may connect two or more tubes.

As can be seen, at least a portion of (e.g., at least a majority of), and perhaps all of the inflatable tubing and grooves within which it resides, may be located in generally surround relationship of the cavity into which molding shall occur.

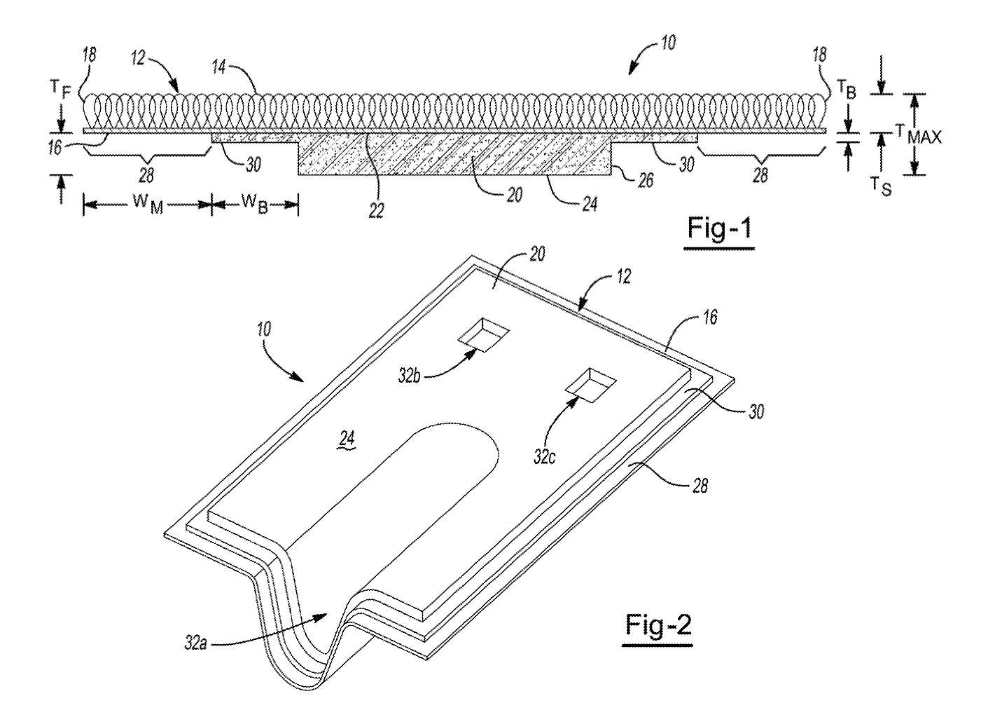

By way of example, illustrative embodiments are depicted in the following. With reference to FIGS. 1 and 2, there is seen an illustrative article 10 (e.g., a foam backed carpet for a vehicle) having a thickness T_{MAX}. The article has a substrate 12 (e.g., shown as carpet in FIG. 1) with a thickness T_{S}. The substrate has a first surface 14 (shown as an upper surface), an opposing second surface 16 and a peripheral edge 18 defined between the first surface and the second surface.

A shaped foam body 20 having a thickness T_{F} (e.g., a maximum thickness) is made of a polymeric material and is attached to the substrate 12. The shaped foam body has a first surface 22 in contact (direct or indirect) with the second surface 16 of the substrate over a major portion thereof (shown as being entirely in contact), an opposing second surface 24 (shown as a bottom surface) and a peripheral edge 26 defined between the first surface and the second surface.

In the space between the peripheral edge 18 of the substrate on the second surface of the substrate and the peripheral edge 26 of the shaped foam body, there is a margin 28 having a width W_{M} that is substantially free of any polymeric material of the shaped foam body. There is also a border area 30 that includes an exposed extension of the polymeric material of the shaped foam body having a generally predetermined shape and size. The border area as seen in FIG. 1 has a generally constant thickness, T_{B}, and thus may also be expected to have a generally constant density over at least 20%, 40%, 60%, 80%, 90% or 95% of the total border area. The border area 30 also includes a width W.

As to all embodiments generally, the border areas of the articles herein may be characterized as having one or any combination of a generally constant width (e.g., within +/−20%, +/−10% or less of an average width), a generally constant thickness, a predetermined pattern, and/or a generally constant density over at least 20% 40%, 60%, 80%, 90% or 95% of the total border area).

As seen in FIG. 2, there may be one or a plurality of three dimensional shapes 32a, 32b and 32c that may arise from molding the foam onto the substrate. In general, for all embodiments the three dimensional shapes may have a topography that extends downwardly, upwardly, and/or laterally in each of the x, y and z axes of the cartesian coordinate system.

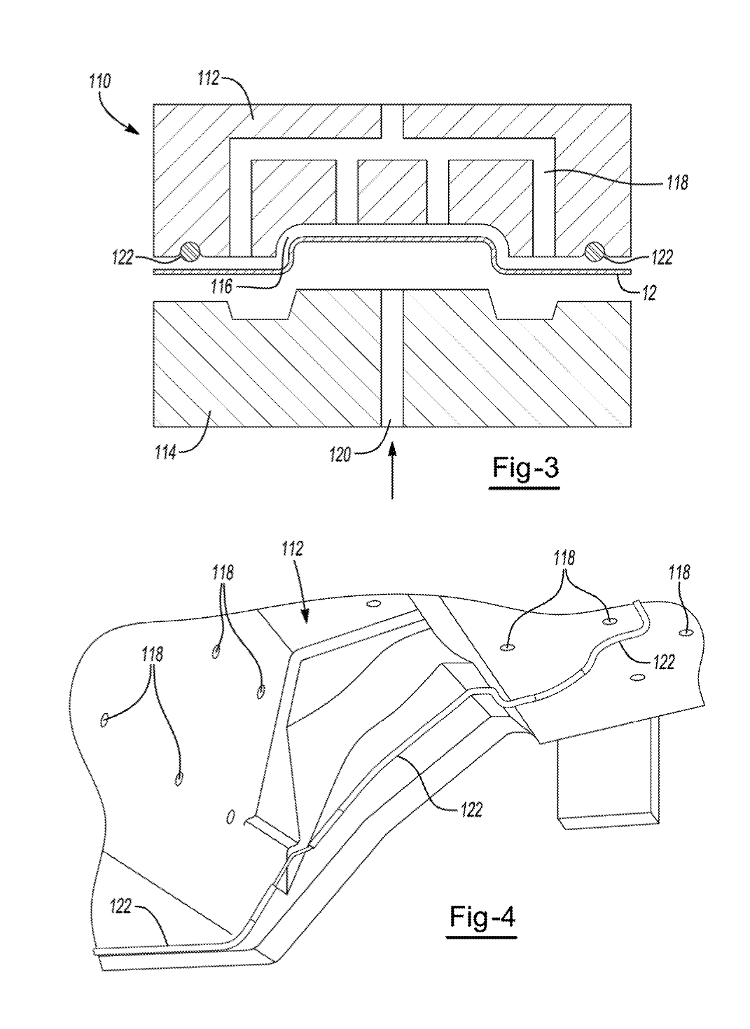

With reference to FIG. 3, there is shown an illustrative tool 110 for use to make an article in accordance with the teachings. The tool has a top mold portion 112 (shown as an upper mold portion, but which may be inverted alternatively), and a bottom mold portion 114 (shown as a lower mold portion, but which may be inverted alternatively). The top mold portion 112 is shown to include a cavity 116 or other structure into for onto) which a substrate 12 (e.g., a shaped carpet) can be received. A port structure 118 may be included for connecting with a source for creating a vacuum (not shown) to help secure the substrate during molding.

The bottom mold portion 114 is shown to have at least one inlet 120 through which a fluid reactant mixture can be introduced to fill the cavity (shown in direction of arrow).

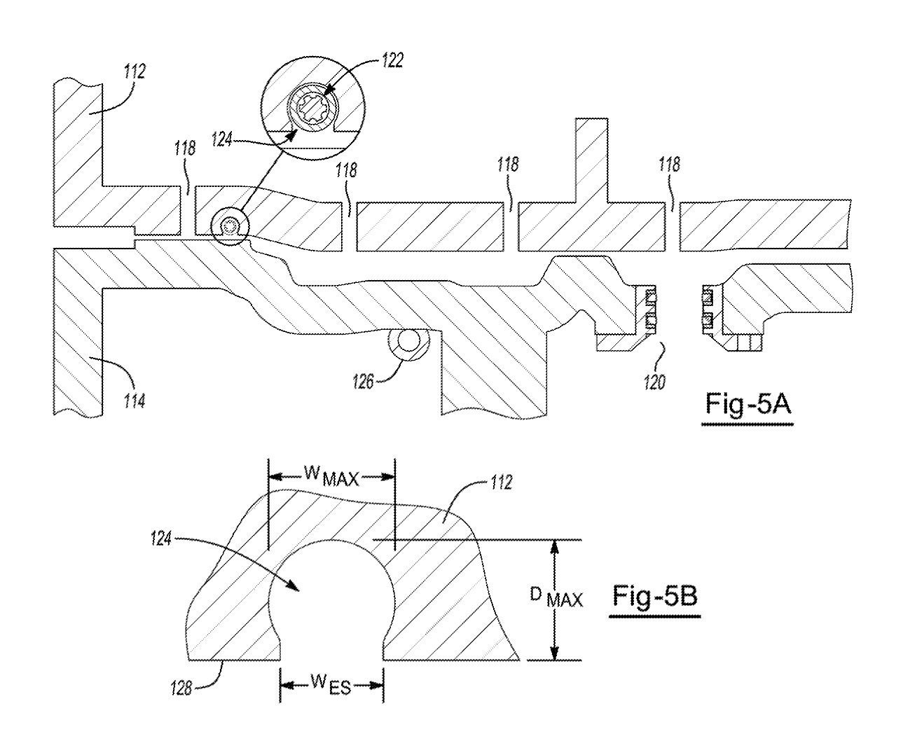

As seen in FIGS. 3 and 4, an inflatable seal assembly may be employed. For instance one or more inflatable tubes 122 may be positioned in the first or upper mold portion (e.g., within a groove 124 of the mold portion (see FIG. 5B)). When the mold portions are brought closer together for filling with the reactants mixture there may be a gap between the mold portions when any inflatable tubes are in a deflated condition. In that manner, while curing in place, the reactant mixture can vent gas built up in the mold, Moreover, as desired the tube can be inflated to bear against the substrate and prevent outward leakage of the reactant mixture, and undesired waste. This can be performed in a controlled manner to arrive at the desired quality of mold fill for the resulting foam body, and also to arrive at the desired margin and border area structure. Further, as seen in this illustration (and as applicable generally throughout the teachings), there may employed an inflatable seal assembly or other device that can be controlled to change a gap distance between opposing mold portions. By operating the seal assembly or other such device to selectively open and close a gap between opposing portions of a mold, venting can be achieved, as well as the achievement of a high quality border area and margin can be realized in a consistently reproducible manner, thereby helping to reduce overall material waste.

As shown in the drawing, and as applicable generally to other embodiments herein, it is also the case that when the gap is closed between opposing mold portions, the at least one seal assembly (e.g., tubes of the at least one seal assembly) bears against the substrate (which desirably may be a single substrate (e.g., a carpet) located on only one surface (e.g., an upper surface) of the foam body). Thus, the foam body, in its expanded state can directly and releasably contact a wall defining a mold cavity during manufacture.

Not shown in FIG. 3 or 4, but which may also be present are one or more passages through or into which a fluid or other heat source or heat exchange medium may be introduced for managing temperature of the mold portions, a plate for attaching to a platen of a press, or any of the other hardware as described previously.

With reference to FIGS. 5A and 5B, there is shown a first mold portion 112, having a plurality of port structures 118. The first mold portion 112 also includes a groove 124 for carrying the inflatable tube 122. The groove 124 includes an undercut portion that receives the tube 122. FIG. 5A illustrates a heating line 126 included on the second mold portion 114 as well as an inlet 120 through which a fluid reactant mixture can be introduced to fill the cavity.

FIG. 5B illustrates an enlarged cross sectional view of the groove 124 (shown without tube 122) of FIG. 5A. The groove 124 penetrates inwardly into the first mold portion 112 from an exposed surface 128. The exposed surface has a width (W_{ES}). There is also a maximum width of the groove (W_{MAX}) which is shown to be larger than the exposed surface width, and maximum depth of the groove (D_{MAX}).

As gleaned from the above, the articles of the present teachings may be free of any foam-impermeable layer. The articles of the present teachings may be free of a covering or layer over the foam body, so that the foam body is exposed in the finished product.

The method of the present teachings may be free of employing any intermediate layer (except a mold release composition) between the polymeric material of the foam body and a wall of a mold portion cavity. Following curing of the polymeric material of the foam body, the method of the teachings herein may be free of any step of removing any cured polymer from any of the tubes of the inflatable seal assembly. The inflatable seal assembly may be completely isolated from the reactants mixture by the substrate.

The following comments apply generally to the teachings herein.

By “predetermined” as used herein, it is meant that it is previously determined during the design and development stages of an article, and it is the intended resulting design from manufacture.

Heights are measured by a cross-sectional distance between opposing surfaces taken perpendicular to a horizontal plane of the article.

Average dimensions are determined by taking at least 25 representative measurements at fixed intervals along a length of a feature, by eliminating the largest and the smallest values and averaging the remainder.

Unless otherwise states, references, to “at least one” also contemplate “a plurality”, one or more, two or more, three or more, etc.

Unless otherwise stated, references to a single substrate includes substrates that are monolithic, as well substrates that include a plurality of layers that are assembled in a generally contiguously adjoining manner over their respective areas to define a single assembled layer. By way of example, a single substrate may include a coated layer, a film layer or the like and remain a single substrate.

Unless otherwise stated, reference to the general term “vehicle herein” also contemplates automotive vehicles.

Unless otherwise stated, reference to the general term “article” herein also contemplates foam backed carpet, and reference to the general term “substrate” herein also carpet.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc, are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consisting of, the elements, ingredients, components or steps.

Plural elements, ingredients, components steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

Relative positional relationships of elements depicted in the drawings are part of the teachings herein, even if not verbally described. Further, geometries shown in the drawings (though not intended to be limiting) are also within the scope of the teachings, even if not verbally described.

What is claimed is:

1. An article, comprising:
a. a substrate having a first surface, an opposing second surface and a peripheral edge defined between the first surface and the second surface;
b. a shaped foam body made of a polymeric material and being attached to the substrate, the shaped foam body having a first surface in contact with the second surface of the substrate over a major portion thereof, an opposing second surface, and a peripheral edge defined between the first surface and the second surface;
wherein in a space between the peripheral edge of the substrate on the second surface of the substrate and the peripheral edge of the shaped foam body, there is a margin that is substantially free of any polymeric material of the shaped foam body, and a border area that includes an exposed extension of the polymeric material of the shaped foam body having a substantially predetermined shape and size.

2. The article of claim 1, wherein the substrate is a carpet.

3. The article of claim 1, wherein the polymeric material is a polyurethane.

4. The article of claim 3 wherein the polymeric material is a cure-in-place polyurethane.

5. The article of claim 1, wherein the shaped foam body is attached by an adhesive bond to the substrate.

6. The article of claim 1, wherein the margin extends around substantially the entirety of the peripheral edge of the shaped foam body, and is spaced apart from the peripheral edge of the shaped foam body only by the border area, and wherein the margin consists of the substrate.

7. The article of claim 1, wherein the border area extends around substantially the entirety of the peripheral edge of the shaped foam body.

8. The article of claim 1, wherein the second surface of the shaped foam body is free of any layer that covers the peripheral edge of the shaped foam body, wherein the second surface of the shaped foam body is free of any layer, or both.

9. A method of making the article of claim 1, comprising a step of foam molding the shaped foam body in at least one cavity of a tool that also carries the substrate, while intermittently venting the tool with an assembly that controllably opens and closes a gap between opposing mold portions of the tool.

10. The method of claim 9, wherein the method includes elastically compressing the substrate without plastically deforming it while closing the gap between opposing mold portions of the tool.

11. The method of claim 9, wherein the method includes the steps of:
a. positioning the substrate in the gap between a firs mold portion and a second mold portion opposite the first mold portion of a mold so that the margin of the substrate is positioned in alignment with at least one inflatable seal assembly carried on at least the first mold portion;
b. introducing a fluid reactant mixture into a mold cavity of the second mold portion so that it fills and at least partially contacts the mold cavity and it at least partially contacts the substrate;
c. curing the fluid reactant mixture while it remains in the mold cavity;
d. intermittently deflating the at least one inflatable seal assembly from an inflated state to a deflated state to vent gasses that build up within the mold; and
e. intermittently inflating the at least one inflatable seal assembly from a deflated state to an inflated state so that both first and second mold portions contact the substrate.

12. The method of claim 11, wherein the method includes a step of drawing at least a partial vacuum to help secure the substrate in place.

13. The method of claim 11, wherein steps are performed that include intermittently inflating and deflating one or more tubes of an inflatable seal assembly to vent gasses that build up within the mold; and for causing the one or more tubes to directly contact and elastically compress the substrate without plastically deforming the substrate.

14. A tool for making the article of claim 1, comprising:
a. a first mold portion;
b. a second mold portion adapted to be brought in opposing elation with the first mold portion,
i. the first and/or second mold portions being adapted to receive a substrate in a space between the first mold portion and the second mold portion;
ii. at least the second mold portion having a cavity defined therein, and at least one inlet through which a fluid reactant mixture can be introduced into the cavity for filling the cavity;
c. at least one gap-defining assembly that extends around at least a portion of a periphery of the cavity, and is carried on the first mold portion, the at least one gap-defining assembly being adapted for engaging the substrate during a molding operation, when in a first state, and for causing a venting gap to arise between at least a portion of the first and second mold portions when in a second state.

15. The tool of claim 14, wherein (a) the cavity is configured so that the molded article has a shape of a floor covering for a vehicle, (b) the second mold portion includes a plurality of openings through which a vacuum can be drawn, or both (a) and (b).

16. The tool of claim 14, wherein the, at least one gap-defining assembly includes at least one inflatable seal assembly.

17. The tool of claim 16, wherein a first inflation state arises upon the presence of a first volume of gas in the at least one inflatable seal assembly, and a second inflation state arises upon the presence of a second volume of gas in the at least one inflatable seal assembly that is higher than the first volume of gas, and
wherein the at least one seal assembly is located within a groove in the first mold portion, and upon inflation at least a portion of the inflatable seal assembly extends outside of the groove for directly or indirectly engaging an upper surface of the substrate.

18. The tool of claim 17, wherein the at least one inflatable seal assembly is located within a groove in the first mold portion, and upon inflation at least a portion of the inflatable seal assembly extends outside of the groove for directly or indirectly engaging an upper surface the substrate.

19. The tool of claim 14, wherein either or both of the first mold portion and the second mold portion include ports for fluid communication with a device for drawing a vacuum for helping to secure the substrate in position.

20. A system containing the tool of claim 16, wherein the system includes a source of fluid in fluid communication with the at least one inflatable seal assembly, a regulator for controllably introducing fluid from the source of fluid to the at least one inflatable seal, a press, and a controller that controls the frequency, duration and/or amount of fluid to the at least one inflatable seal assembly.
